(19) United States
(12) Patent Application Publication
(10) Pub. No.: US 2014/0247342 A1
(43) Pub. Date: Sep. 4, 2014

(54) Photographer's Tour Guidance Systems

(71) Applicants: Peter Ellenby, San Francisco, CA (US); Thomas Ellenby, San Francisco, CA (US)

(72) Inventors: Peter Ellenby, San Francisco, CA (US); Thomas Ellenby, San Francisco, CA (US)

(73) Assignee: GeoVector Corp.

(21) Appl. No.: 13/783,344

(22) Filed: Mar. 3, 2013

(51) Int. Cl. H04N 5/232; G06F 3/0484

(52) U.S. Cl. CPC H04N 5/23222; G06F 3/0484
USPC 348/135; 715/709

(57) ABSTRACT

Photographer's tour guidance systems are formed about a computer-based processor made responsive to location, position and orientation, time-of-day, manual user inputs, among others to provide photo exposure suggestions based upon. information stored as photo tour definitions. In espouse to user requests and sometimes in combination with present conditions such as time, location, weather, et cetera, a database request is executed against stored photo tour data to produce a result set of photo exposure suggestions in agreement with a tour definition. These photo exposure suggestions may he used both manually and automatically to assist a photographer user in making photo exposures to form as natural series of related photographs. These systems may be directly coupled with a modern electronic DSLR type camera and may operate via user controls and interfaces thereof. in alternative versions, these system have independent control and user interfaces with outputs coupled to a DSLR control.

### BACKGROUND OF THE INVENTION

1. Field

The following invention disclosure is generally concerned with photographic apparatus and specifically concerned with photographer's electronic guidance systems which provide point-of-interest tour information.

2. Prior Art

Computer technologies have enabled remarkable changes to many of our everyday activities. From how we communicate with our families, to how we plan a journey computers today greatly influence the manner in which we performed many activities. Even something so artful and beautiful as photography can be greatly improved and enhanced by way of computer supporting systems. With the advent of digital cameras, and most particularly ‘high-end’ or ‘prosumer’ digital single lens reflex DSLRs type cameras, great opportunity arose for photographers to benefit from advances in general computer technologies.

In one illustrated example, a digital camera coupled with a GPS position determining system includes a computer to provide digital data files of photographs with names which are particular to the locations from which the photograph is made. Such systems are first taught in exhaustive, detail in U.S. Pat. No. 6,657,661 by inventor Cazier of Colorado. In a peculiar shortcoming of these systems, image files are given names associated with the places from which the image was captured rather than the names associated with the location of the image subject mover. For example, a photographer on the bayfront shore in Richmond Calif. may make photographs of San Francisco, Oakland, Alcatraz, Sausalito, Madera and San Rafael. However, all files would he named with a prefix “Richmond” in accordance with the teachings of Cazier. This, despite the fact that none of the images are actually of Richmond. While Cazier's teachings are probably useful for tourists visiting Paris, these systems are limited and their applications quite narrow in scope.

Another important illustrative attempt to couple advanced computing systems and location based informatics can be discovered in U.S. Pat. No. 7,477,295. In this invention by Tanaka of Japan. a GPS module determines position of the camera unit and the information is transmitted from the OPS to the camera via radio I/F. after a photograph is made, it is stored as an electronic file on a local memory card. In addition, to the image, a thumbnail (highly abbreviated) image is also stored. Further, a computer calculates a camera attitude and range (distance between photograph site and the object being photographed) according, to position coordinate data. Measurement data, i.e.. position coordinate data, object position coordinate data, camera attitude, distance between photographer site and the object, all may he attached to the digital file which represents the image. Thus, data measured during the exposure may be appended to the digital files of images.

In yet another important invention of the art entitled “Electronic guide system, contents server for electronic guide system, portable electronic guide device, and information processing method for electronic guide system” an the invention presented by inventors Kobuya et al, of Sony Corp. was granted Oct. 31, 2006 as U.S. Pat. No. 7,130,742. An electronic tour guide is affected for tourists where a server provides guide information including places of interest as well as map data. The server additionally provides content in agreement with a user's predefined specifications. Custom tour guide content is stored in an electronic guide apparatus. Upon arrival at a destination, for example at an airport counter, electronic, guide apparatus with custom information preloaded thereon may be collected and used by the user to take to a selected destination for further consumption of custom content.

While systems and inventions of the art are designed to achieve particular goals and objectives, some of those being no less than remarkable, inventions of the art have limitations which prevent uses in new ways now possible. inventions of the art are not used and cannot be used to realize the advantages and objectives of the invention taught herefollowing.

### SUMMARY OF THE INVENTION

Comes now, Peter Ellenby and his brother Thomas Ellenby with inventions of photographer's tour guidance systems including photographic apparatus for making photograph images where the apparatus provides suggestions regarding points of interest related to a prescribed theme or topic. It is a primary function of these tour guidance systems to provide computer based systems which respond to various stimuli by providing point-of-interest suggestions to a photographer with respect to a organized tour.

A photographer's electronic tour guidance system includes preprogrammed application-specific computer logic arranged to recall tour data from a library of stored photo tour definitions. Photo tour definitions may be devised and provided to a memory or library in advance of use of these systems. A photo tour definition can include specification of a set of photographs to be made or performed by a photographer following the tour guidelines. Particularly, a series of proposed photo shooting vantage points, shooting angle, camera settings, environment, time of day, among others may be included as included factors of these predefined photo tours. A user may recall at least one photo tour definition of which certain details may be presented graphically at a user interface such as a display or monitor. In accordance with photo tour details suggested, a user photographer manipulates her position, location or orientation, the camera pointing direction, camera settings, among others, to effect a photo of exposure in agreement with the photo tour dentitions. A series of photo ‘exposures’ may be made in a single tour whereby the end result produces a collection of photographs having associative properties.

A photography tour is realized where a set of related photo exposures definitions are presented and executed serially. For example, a plurality of photo exposure definitions all associated with the Dutch city of Amsterdam may be presented serially. A photographer following the photo tour provided by the apparatus permits the photographer to execute a photo exposure series as she moves from one photo to the next as she is led about important photographic landmarks of Amsterdam city. In one example, the litmus canal boats of Amsterdam which have a prescribed course with noted landmarks distributed about the well known course. When a photographer boards same canal boat, she may query a database to find available a corresponding photo tour. For example, she might run a query with a tour boat company's name and the name of the boat course to be taken. Based upon this information, the database suggests possible photo tours which might synchronize with the course taken by the boat. As the boat advances on it course, the phototour may prompt the photographer into action at all the important photo landmarks sights so that a complete photo series is assured at the completion of the boat tour.

Alternatively, a photography tour of these systems may also include a walking tour of a single landmark such as the Coliseum of Rome. A plurality of photo exposure set-up definitions each relating to the Coliseum can be dispensed serially with respect to a logical walking path in a manner whereby a photographer may walk about, shooting photographs in accordance with the specified parameters, to form a still image visual. documentary of a visit to the famous Roman landmark.

In one important aspect of these systems, tours are arranged whereby they may also be executed. in a non-serial fashion, but rather in random access mode. In a random access mode, the set of photo tour stops (photo exposure lists) may he defined and presented to users as a scrollable list. A user may visit each member of the list in an order at will. At each, a photograph exposure may be made in accordance with the tour definitions. At that point, the photographer causes the list to he marked or noted that the prescribed photo tour ‘task’ is completed. In this way, a photographer ‘collects’ photos (photo exposure events) in time and works to complete the task list at a pace desired. At each step, ‘checking off’ as complete the photo making task. In this way, a photographer is free to advance about the tour at a desired pace and in any order she prefers. This type of tour is a distinct from the photo tour described in conjunction with the Amsterdam canal boat tour where the route and pace is not controllable by the photographer. Nevertheless, both types of these photo tours are anticipated herein these systems.

In general, these systems are formed of the following electronic modules coupled together as described. A programmed computer arranged with stored application-specific program code and a query engine coupled to a photo tour definition library. Query requests produce recall of a resultset including at least one photo tour definition which contains sets of photo exposure specifications including among others: photo shooting vantage/location, camera orientation and attitude, and/or camera settings. These photo tour definitions may be presented at a display type user interface where partial representations of them may be made visually and/or graphically. A user photographer may further interact with a resultset of photo tour definitions by scrolling through a plurality of them, for example by way of a control module unit, which further drives code execution with respect to the application being run or executed on the computer processor of the programmed computer.

In all eases, a programmed computer runs a request query against a library of stored photo tour definitions to produce a resultset of at least one photo tour definition which may be applied to a camera automatically or manually to realize the photo exposure set in accordance with details of the photo tour definitions.

### OBJECTIVES OF THE INVENTION

It is a primary object of the invention to provide a photographer's tour guidance system.

It is an object of the invention to provide photographic equipment which suggests point-of-interest lists or photo subject lists in response to requests for same by a photographer.

It is a further object to provide computer based photographic equipment with a prescribed library of stored photo tour data.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set firth by appended claims, but do not appear here as specific examples. It will he appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a block diagram of a photographers guidance system and its major sub-systems;

FIG. 2 is another important block diagram where a computer based system taught here is coupled to a digital camera;

FIG. 3 illustrate additional important couplings between cooperative related systems and these photographer's guidance systems; and

FIG. 4 presents another block diagram with special relation to a DSLR subsystems.

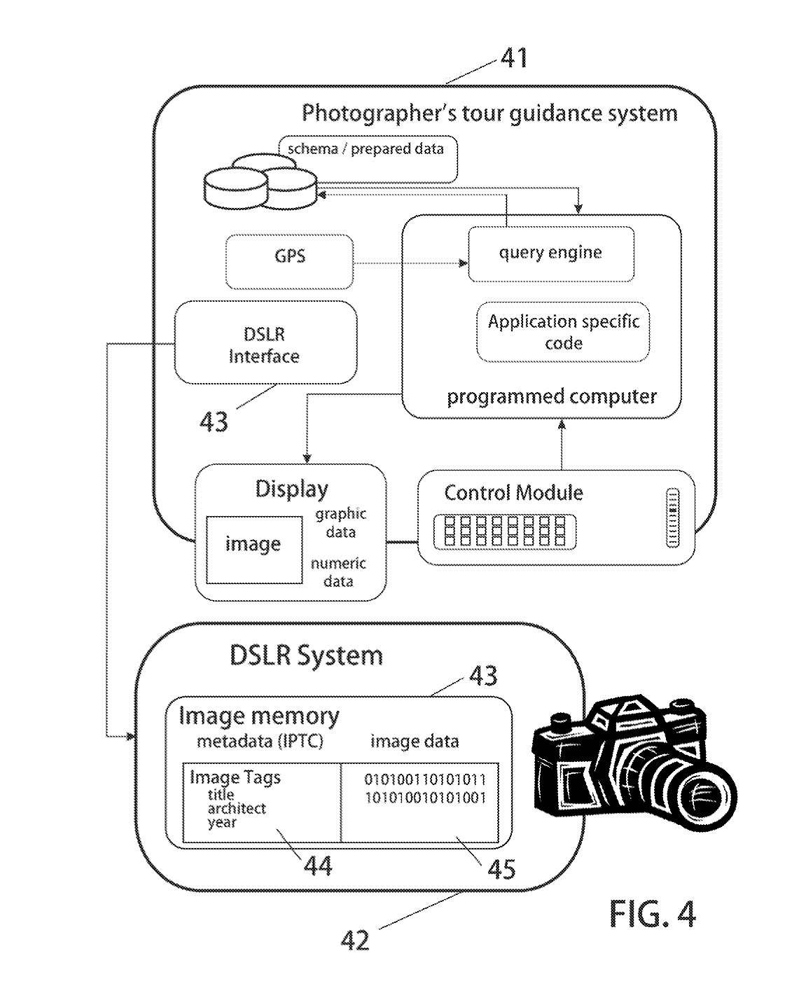

### PREFERRED EMBODIMENTS OF THE INVENTION

In accordance with each of preferred embodiments of inventions presented herein, photographer's tour guidance systems are provided. It will be appreciated that each of the embodiments described include an apparatus and that the apparatus of one preferred embodiment may be different than the apparatus of another embodiment. Accordingly, limitations read in one example should not be carried forward and implicitly assumed to he part of any alternative example.

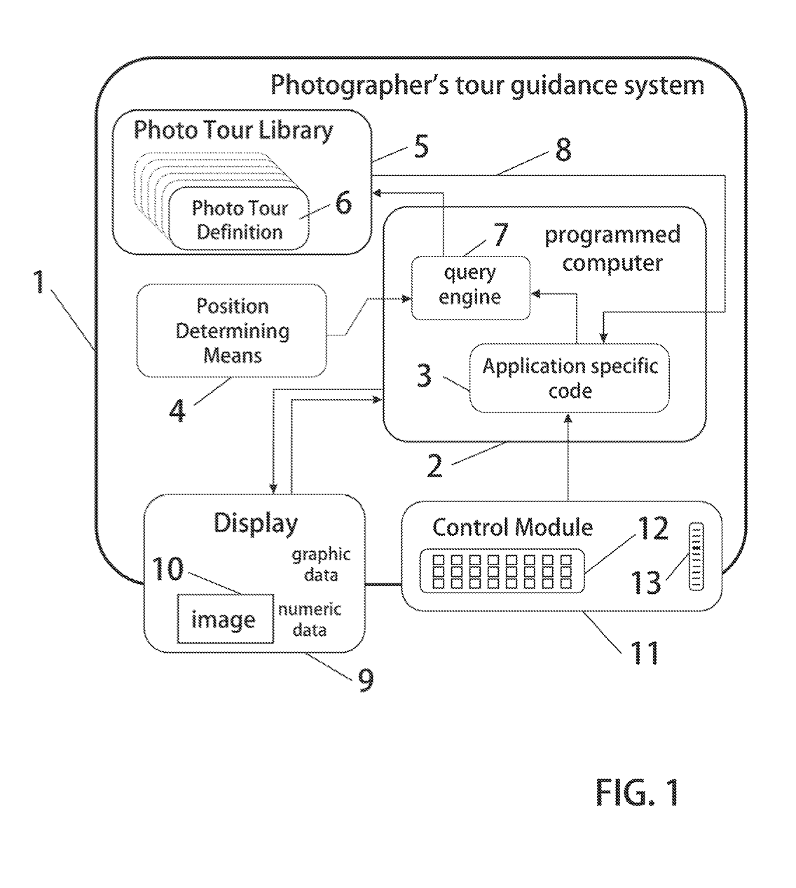

With reference to FIG. 1., one gains a most complete understanding of a general version of these photographer's tour guidance systems. An example photographer's tour guidance system 1 is primarily comprised of a programmed computer 2 With application-specific program code 3, a position determining means 4, and a photo tour library 5.

Application-specific program code is devised and provided to execute control logic which regulates transactions between various of system components. Code is prepared with knowledge and understanding of system objectives and system architecture. The code which is particular to the structure and nature of all elements taught herein, is stored in a manner whereby it may be executed from time-to-time when the device is performing in normal use.

A position determining means such as GPS receiver is arranged with its reference point coupled with the device—that is, it is set to determine the position/location wherever the camera is at any given, time. In most versions this merely means locating the GPS antenna within the system primary hardware. While elements or these systems may be implemented as distributed systems, i.e. in particular the photo tour library, there is a primary hardware unit which is necessarily mobile and serves as a position reference for cooperating parts. In most preferred versions, the primary hardware unit includes system elements described as an integrated DSLR (digital single lens reflex). While the term ‘single lens reflex’ carries over from cameras from long ago—the term is now associated with high quality, high performance electronic digital cameras.

The photo tour library 5 may be embodied as a data storage type apparatus and may he deployed as a conventional database. Commonly used databases such as MySQL or SQLServer may be configured to serve the objectives and performance of these photo tour libraries. These databases include mechanisms such as custom-designed schema. A database schema forms associations between data elements whereby they are bound together—for example by way of a primary key. In addition, a photo tour library of these systems includes preloaded stored data, the data being stored within the schema. in particular, a plurality of photo tour definitions 6. A photo tow' definition is comprised of a handle or reference, a parameter list such as name-value pairs, executable code, and sometimes one or more images.

A photo tour definition is embodied as a ruleset which specifics a group of discrete photographs to be made or object images to be captured. While the notion of ‘tour’ certainly carries a spatial context and most anticipated tours are comprised of a group of photographs indeed related spatially, in other alternative photo ‘tours’ a most abstract notion of tour is considered, For example, a photo tour may also include a ‘tour of springtime’—in such tour, one might he proposed with the task of making a collection of photographs of blooming tree flowers. Over the course of several weeks or even months, one might progress through the tour by executing photographs of various trees as they come into bloom.

In a more conventional sense, these photo tours are more typically arranged as a set of photograph proposals where each member of the set has similar relation to a common theme, location, landmark or topic, as the other members of the set. For example, one tour may be characterized as a landmarks of San Francisco' photo tour. Popular landmarks proposed as subjects for photographs and the tour guide a photographer into preferred circumstance in which these photographs might be made. For example, vantage point, lighting conditions, field-of-view compositions, et cetera.

Another important feature of some of these photo tour definitions relates to its theme or association with a common topic or concept. In one illustrative example, a certain photo tour definition may have an association with a location—for example: Washington, D.C. In another example, a photo tour task list may have an association with a particular landmark like the Golden Gate Bridge. As the Golden Gate Bridge is a landmark popular with tourists, most visitors appreciate making photographs of the famous landmark. For purposes of this discussion, a ‘photo set’ or ‘resultset’ collection of photo exposure suggestions is generally particular to some common subject matter, topic, feature, landmark, et cetera which makes a good cohesive collection of photographs. in some versions, a photo tour task list results in the production of a ‘photo essay’ of sorts and the collection of photographs made in the tour cooperate together to tell a story having a common central meaning. Thus, a subject of interest or point-of-interest may be represented by a photo set of exposures. It is important to appreciate that the viewpoint specification of any particular photo exposure definition is generally not colocated with the photo subject. In other words, the position of a proposed photo exposure viewpoint is normally in a location near, but not common with the position in which the subject of the photo lies.

While a primary aspect of these photo tours relates to the spatial nature of any particular subject, one should remain aware that ‘photo tour’ may also include a tour of a more intangible aspect. A tour of springtime for example. While springtime is not characterized as a location nor a place, it nevertheless remains a viable concept upon which a photo tour of these systems may be arranged. Accordingly, a certain photo tour may include a ‘season’ association.

A photo tour definition may also include an association characterized as a photographic effect or feature—such as ‘reflections’. Many other photo tour definition topics will become more apparent in consideration of examples presented in detail herefollowirig. It should he further appreciated that while not all possible associations can be described here due to the fact that their number is infinitely great—one will understand that the essence and core of the invention doesn't change when a new type of photo tour topic or subject association is introduced. The principal, which is to be clearly understood is that topics or themes may he used as basis from which photo tour definitions may he created.

As many of the most interesting tours devised are dependent upon the positions or locations in which some subjects lie, these systems generally require highly accurate measurements with regard to the instant location of the imaging device. Position determining means conveys position data to the computer in response to an initialization step and sometimes continuously throughout tour execution. Based upon position information received, among other information such as tour topic or theme specifications, a query engine 7 forms a database query to recall stored information. A photo tour definition which may include a plurality of photo exposure suggestions is returned 8 to the computer.

These photo exposure suggestions may be reviewed and examined by as user. For example the elements of the tour, the photo exposure suggestions may be presented in a scrollable list. Application-specific code is arranged to parse the photo exposure suggestions and ‘play’ them, or present them in example, one-by-one at a display type visual, use interface 9. Most particularly, images 10 may he presented alongside with graphic and text/numeric data.

While viewing photo exposure suggestions which are part of a selected tour, a user in may use as control module 11 with tactile peripherals such as a keyswitches 12 or thumbwheel 13 to interact with the application in consideration with the photo tour being executed. For example, a user may ‘select’ a particular photo exposure suggestion for further action.

Accordingly, a most general version is presented as the block diagram of FIG. 1. While these systems are sometimes arranged independent of any camera apparatus, certain versions are preferably devised in close cooperation and connection with and sometimes highly integrated with digital cameras.

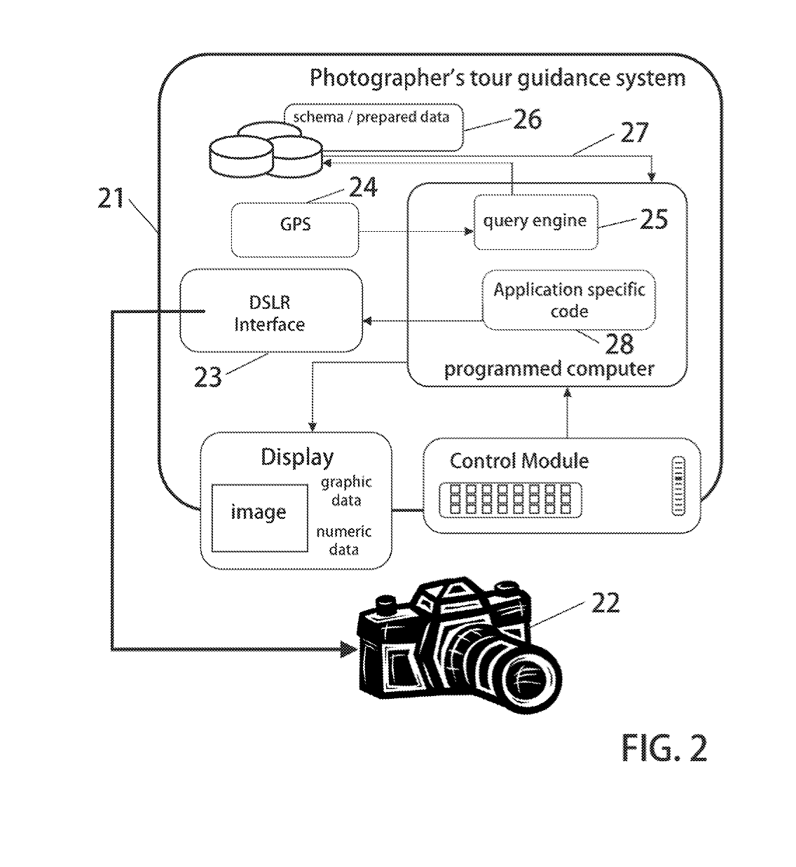

FIG. 2 describes via diagram an important version where the system is directly integrated with a modern digital electronic camera. While some modern digital cameras today include powerful computing facility, large memory and sometimes even GPS, they typically lack other elements described here throughout this description. In some versions of these apparatus where a photographer's tour guidance system 21 is tightly integrated with a DSLR 22, a DSLR interface 23 may be arranged as part of the system whereby control commands generated by the system in agreement with a user selected photo set-up descriptors are transmitted to the DSLR. and operational states of the camera are adjusted in accordance with photo set-up descriptor parameter details. In these versions, a GPS 24 presents location data to the query engine 25 which generates a database query in view of a prescribed set of photo exposure descriptions—each unique photo exposure having associated therewith a ‘viewpoint’ spatial construct. That is the database schema and prepared data 26 are sometimes provided with a consideration of the location and nature from which a photograph may be made. Details regarding photo shooting viewpoint or shooting vantage are passed with a photo exposure or set-up descriptor 27, By using this information, a user can easily make a photo exposure in accordance with the suggestion. Once a photograph is made as suggested, the user can mark the ‘task’ as complete and proceed to the next photo exposure of the photo tour as defined in the task list of photo exposure to be made. In addition to viewpoint, other photo set-up information may include attitude, lens magnification, shutter speed, exposure information, et cetera. Recalling from the description of FIG. 1 a user may select, one from a plurality of photo set-up descriptors. Once a photo exposure of any particular photo tour is selected for execution, a photo set-up descriptor associated therewith may be used by the application-specific code 28 to drive the DSLR interface and control and initialize the DSLR subsystems in accordance with preferences defined by the exposure definition. Of course, many of these are subject to override settings which a user might apply. The DSLR interface appropriately coupled to a digital camera whereby changes the operational states of the camera 22 in agreement with information recalled as the photo exposure set-up descriptors.

In review, as part of a photo tour comprised of a set of various photo exposure definitions, a user may take a mobile unit of these systems including a DSLR to a site of interest and automatically receive photo set-up suggestions. A user may further specify parameters such as ‘sunsets’ which might further modify the essence of a selected tour to incorporate that theme or other similar theme. Prior to execution of a photo exposure which is part of a photo tour, the computing system presents the user with parameter sets of details which can be adjusted by the photographer to bring about an actual exposure. Thereafter an exposure is made in accordance with the suggestion, the photo exposure is ‘ticked’ in the list and the tour proceeds to the next uncompleted photo task.

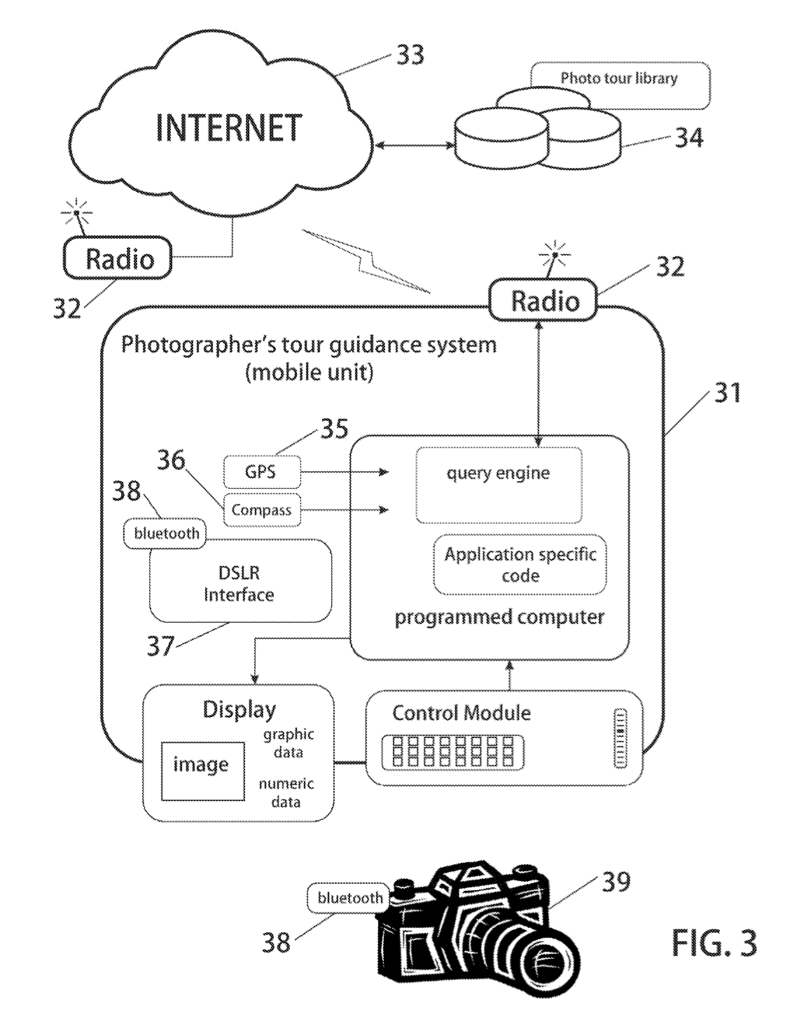

FIG. 3 illustrates important: communications aspects of these photographer's guidance systems 31. Because some comprehensive versions of these tour systems include very complete libraries of photo exposure lists, among other reasons, it is convenient to embody portions of the system via remote servers in communication with mobile portions. A radio (wireless) communications link 32 is established whereby a mobile device as described is coupled to and exchanges messages by way of the Internet 33 with remote servers which might include comprehensive data stores. Calls to a remotely located photo tour library 34 hosted as a server produce replies over the same wireless communications link whereby the photographer's tour guidance system mobile unit receives a limited set of data including a plurality of highly relevant photo exposure suggestions. One will appreciate that mobile systems of limited memory and computing resources benefit when coupled to remote servers as described. In addition, self-contained versions with all data on-board arc further limited with respect to frequent updates. Remote photo tour libraries offer real-time fresh updated data to all users who might couple therewith by a single one-time change at as library arranged as a remote server.

When a mobile unit is carried to a shooting location or venue, the OPS 35 measures the device's position and reports position data to the application-specific programmed computer. In one special alternative version, an electronic compass 36 may he also included. Device attitude information may also be used in some data queries to request a photo exposure definitions via a more narrowly defined query. If a photographer who uses these systems in Washington. DC is located at 9th St. NW in the mall facing West, the compass can detect the pointing direction or attitude of the mobile unit and provide the query engine this information. Thus merely pointing West from this location causes the photo exposure definitions recalled to have the Washington Monument as an image subject. However, if the device is turned 180° and pointed East, then photo suggestions which are part of the tour returned only includes photo exposure definitions having the Capitol has a subject. That is, the pointing attitude drives the query engine to recall tour photo data which most likely relates to that which is being pointed at (addressed). Accordingly, both position and attitude can he used to form queries to recall specific photo set-up descriptors.

In one important version, the compass has a reference direction—the direction which is subject to the attitude determination. This reference direction is preferably coupled to the optical axis of a camera in some systems; and more particularly the lens of the camera. When the camera is pointed, the compass determines the pointing direction of the camera rather than an arbitrary reference of the mobile unit. Accordingly, recalled photo exposure suggestions can depend upon the instantaneous position and attitude of the camera.

A radio communications link, is also useful in some versions. The mobile unit is sometimes coupled to a camera by way of a Bluetooth type communications link 38. A DSLR 39 having a complementary Bluetooth transceiver permits the camera to be in continuous data communication with nearby photographer's guidance system mobile units. These alternative versions offer some hardware variation each version having important benefits and drawbacks. In one particular example of this version, a mobile telephone may include an ‘app’ running thereon whereby the app controls and dispenses the tour features. Information displayed on the mobile telephone interface (touchscreen) may drive the tour features and execution while data is passed to a cooperating DSLR for control and settings which might be effected therein.

A great richness of information relating to any particular photograph exposure, or photo set-lip becomes available in normal operation of these tour systems. While it is known in the art. to save an image file with pixel data alongside metadata, for example in accordance with the IPTC format used with TIFF or JPEG image data files, it was certainly not heretofore possible to automatically append image files with data relating to photo subject matter, the environment, and certain aspects of the exposure characteristics. For example, in systems of the art it is presently impossible to automatically append an image file with information about the subject being photographed. For example, in today's modern cameras when taking a picture of the golden gate bridge, the file metadata does not read “Golden Gate Bridge”. It may include the date, exposure details, and manually added fields such as “San Francisco” or even “San Francisco Bay Shots”. But one could not achieve a field label reading “Golden Gate Bridge” without having to stop and enter text data manually describing each and every subject matter which can be photographed. It is particularly cumbersome to label each photograph as it is made. As such, “Golden Gate Bridge” in most circumstances is too narrow or too detailed of a description unless one intends to shoot a series of photographs where each one includes the Golden Gate Bridge. If one decides to photograph another subject, a new text label must be manually prepared. However it. is reasonable to answer “San Francisco” as a text label for photographs made during a tourist trip to the city. Many photographs made during the tourist trip would accurately be described as “San Francisco”. Since it is a static field applied to all images without regard for what is actually being photographed.

In systems 41 taught here, a photo exposure definition may include information about the actual subject of the photograph being made. A photographer on Alcatraz

Island pointing her camera 42 West would automatically invoke recall of a photo set-up descriptor including the title of the subject matter the photograph to be made; i.e. “Golden Gate Bridge”. Accordingly, “Golden Gate Bridge” can be stored to memory 43. In addition, other ‘image tags’ 44 relating specifically to the subject being photographed may also he saved as part of the image file—e.g. title; architect; year built; et cetera.

These image metadata tags may be stored alongside the conventional image data 45. if the same photographer and then turned approximately 180° to face East and make another photograph, a photo set-up descriptor recalled would have a subject matter title “Treasure Island”. The user need not enter these manually, the mere act of pointing the camera towards the subject being photographed invokes an automatic change to metadata stored with the image file.

Information from a photo exposure definition is passed from the photographer's guidance system to the DSLR via the DSLR interface whereby the file write system applies data fields to image files in accordance with IPTC style metadata. In this way, automated subject matter labeling in agreement and in support of the tour is applied to captured images. This scheme is not limited to subject titles. Rather a great deal of information may be similarly apply and associated with image files at the time of exposure. Any information which can he stored as part of a photo exposure definition can be finally attached as an image tag because the photographer's tour guidance system recalls associated data as part of the photo exposure definition. Accordingly, image tags now may include far more detail relating to any image captured if image capture is preceded by the step of recalling a photo exposure definition. As described herein, this step may be invoked manually by a photographer selection from a plurality of photo exposure definitions in a photo tour; or alternatively in combination with an automated response taken in response to a system position and/or attitude as dynamically measured in real-time.

Additionally the information relating to objects identified as being within a captured image may be used to ensure that at least one image has been captured of objects on a list. Such a list may relate to a location, for example the top 20 tourist sites in Paris, and such lists may be pre-set or user generated or modified. It should be noted that at its most basic level such a check-list of objects to be photographed does not need to include specific locations and viewing angles to capture the image of the object from but more advanced applications of such a list may include this information as described above. Advanced versions of such system may also be able to determine if the desired object was actually visible, e.g. not blocked by a building or inclement weather or not lit at night time, in the image and not merely in the field of view of the camera as determined by the position, pointing direction and zoom state of the camera

One will now fully appreciate how photographer's tour guidance systems based upon computerized processing and stored information operable for making suggested image series may be realized. Although the present invention has been described in considerable detail with clear and concise language and with reference to certain preferred versions thereof including best modes anticipated by the inventors, other versions are possible. Therefore, the spirit and scope of the invention should not he limited by the description of the preferred versions contained therein, but rather by the claims appended hereto.

It is claimed:

1) Photographer's electronic tour guidance systems comprising:
a programmed computer;
a photo tour library;
an interactive control module; and
a display type user interface,
said photo tour library is coupled to said programmed computer whereby stored photo tour definitions may be recalled and presented at said display type user interface, said photo tour definitions comprising a plurality of photo exposure suggestions.

2) Photographer's electronic tour guidance systems of claim 1, said programmed computer comprises application specific code arranged to administer a photography tour.

3) Photographer's electronic tour guidance systems of claim 2, said photography tour is characterized as presentation of a series of photo exposure suggestions in a logical manner.

4) Photographer's electronic tour guidance systems of claim 3, said logical manner includes a finite series of photo exposure suggestions presentable in a list.

5) Photographer's electronic tour guidance systems of claim 3, said logical manner is further characterized as a plurality of photo vantage sites all coupled by a common path characterized as a ‘walking tour’.

6) Photographer's electronic tour guidance systems of claim 3, said logical manner is further characterized as a plurality of photo vantage sites all coupled by a common path characterized as either from the group: city bus route; maps; metro routes; and city tour.

7) Photographer's electronic tour guidance systems of claim 3, said list is characterized as a ‘checklist’ in which completed elements of the list are marked or indicated as completed as those tasks are done.

8) Photographer's electronic tour guidance systems of claim 1, further comprising: a query engine coupled to a position determining means whereby recalled photo tours are dependent upon an instant position of the device.

9) Photographer's electronic guidance systems comprising a programmed computer;
an object database;
a position determining means;
an attitude determining means;
an imager; and
a display type user interface,
said object database is coupled to said programmed computer whereby stored object location information may be recalled and compared to a field-of-view of the imager based upon position and attitude of the imager at a time an image is captured to determine whether any objects are within the field-of-view of the imager.

10) Photographer's electronic guidance system of claim 9, said object database comprises data elements including objects characterized as being good photographic subjects.

11) Photographer's electronic guidance system of claim 10, said data elements are further characterized as a list of object names and associated object parameters.

12) Photographer's electronic guidance system of claim 11, said associated object parameters are Further characterized as a group comprising one or more of location, size and associated 2D or 3D graphics or models.

13) Photographer's electronic guidance system of claim 12, said programmed computer comprises application specific code arranged to record the identity of objects determined to be within the field-of-view of a captured image.

14) Photographer's electronic guidance system of claim 13, said programmed computer further comprises application specific code arranged to record a list of objects identified as being within the field-of-view images captured by the system and display confirmation of the capture of said identified objects at said display type user interface.

15) Photographer's electronic guidance system of claim 13, said programmed computer further comprises application specific code arranged to record and compare a list of objects identified as being within the field-of-view of images captured by the system to said object database and display confirmation of the capture of said identified objects at said display type user interface.

16) Photographer's electronic guidance system of claim 15, said programmed computer further comprises application specific code arranged to record and compare a list of objects identified as being within, the field-of-view of images captured by the system to said object database and display a list objects not identified as being within the field of view of images captured by the system at said display type user interface.

17) Method for determining if an image ala desired object of known location has been captured by an image capture means comprising the steps of:
determining the position of the image capture means;
determining the pointing direction of the image capture means:
determining the field of view of the image capture means; and
determining if the known location of the object is within the field of view of the image capture means.

18) Methods of claim 17 further comprising the step of indicating that the object has been captured and checking it off a list of objects that an image is desired of.
